(19) United States
(12) Patent Application Publication
(10) Pub. No.: US 2016/0247393 A1
(43) Pub. Date: Aug. 25, 2016

(54) VEHICLE DRIVING ASSISTANCE APPATARUS

(71) Applicant: USHIO DENKI KABUSHIKI KAISHA, Tokyo (JP)

(72) Inventors: Masashi Okamoto, Hyogo (JP); Hidekazu Hatanaka, Tokyo (JP)

(21) Appl. No.: 15/048,780

(22) Filed: Feb. 19, 2016

(30) Foreign Application Priority Data
Feb. 20, 2015 (JP) 2015-031537

(51) Int. Cl. G08G 1/005; B60Q 1/00; B60Q 1/26

(52) U.S. Cl. CPC G08G 1/005; B60Q 1/26; B60Q 1/0023

(57) ABSTRACT

A vehicle driving assistance apparatus installed in a vehicle displays a predetermined light pattern on a road surface around an own vehicle. The vehicle driving assistance apparatus includes a coherent light source that emits a light source beam, a road surface projection optical system that scans the light source beam and emits the projection beam, a road surface presence information retention section and a control circuit. The control circuit stops the projection beam toward the position where the road surface is absent.

### CROSS REFERENCE TO RELATED APPLICATIONS

This application claims the benefit of Japanese Priority Patent Application JP 2015-031537 filed on Feb. 20, 2015, the entire contents of which are incorporated herein by reference.

### BACKGROUND

The present disclosure relates to a vehicle driving assistance apparatus that scans light emitted from a coherent light source such as a semiconductor laser, to draw a predetermined light pattern on a road surface around an own vehicle, and enables a driver of the own vehicle, drivers of other vehicles, pedestrians, and an environmental condition detector to recognize the drawn light pattern, thereby contributing to road safety.

As an existing technology that displays any light pattern on a road surface around an own vehicle with use of a laser beam such as a semiconductor laser and enables a driver of the own vehicle, drivers of other vehicles, pedestrians, and an environmental condition detector to recognize the displayed light pattern, for example, a technology disclosed in Japanese Unexamined Patent Application Publication No. H05-238307 is exemplified. The technology disclosed in this document projects a visible spot marker or a diagram such as a polygon through scanning with use of a two-dimensional galvanometer, on a front position distanced by a predetermined length from the vehicle on a road surface. This makes it possible to enable pedestrians and drivers of other vehicles to recognize presence of the own vehicle.

Further, in Japanese Unexamined Patent Application Publication No. 2003-231450, disclosed is a technology in which an image pickup apparatus acquires a light pattern formed on a road surface by a laser beam that is emitted by the own vehicle and other vehicles and a condition to be noted in traveling of the own vehicle is determined based on information of the light pattern. In this technology, a traveling track where the own vehicle is supposed to travel is calculated based on a vehicle speed, a motion state quantity, a steering angle, and steering force of the own vehicle. Right and left boundaries between a zone where the vehicle passes and a zone where the vehicle does not pass in a case where the own vehicle is assumed to travel on the calculated traveling track are calculated, and a scan actuator scans a laser beam to draw a part of the boundaries necessary for safety depending on the speed and other factors.

Further, in Japanese Unexamined Patent Application Publication No. 2004-526612, disclosed is a technology of displaying a light pattern on a road surface behind the own vehicle with use of a method used in a field of illumination effect for a spectacular show, and providing a following vehicle with information when an accident occurs or the own vehicle is urgently stopped.

### SUMMARY

These technologies just mentioned above are based on the assumption that the projection beam forming the light pattern projected on the road surface is irregularly reflected by the road surface and is diffused substantially uniformly in all directions less depending on an entering direction of the light. In addition, these technologies are based on the assumption that emitting the projection beam downward from a position as high as possible of a vehicle, for example, in a case of a passenger car, from a vicinity of a top side of a front windshield before a driver's seat does not cause the projection beam to directly enter eyes of a driver of other vehicle and pedestrians.

These technologies, however, may cause an issue when the vehicle travels a place where a downward gradient of the road surface increases as the distance from the own vehicle increases. The issue is described with reference to FIGS. 3A to 3D that are schematic diagrams each illustrating a concept relating to the technology of a vehicle driving assistance apparatus according to an embodiment of the disclosure. When the projection beam (Fo) is projected forward, for example, as illustrated in FIGS. 3A and 3B, the projection beam (Fo) forming a light pattern projected on the road surface does not strike against the road surface at a place immediately before an own vehicle (Co) travels the top of an uphill or immediately before the own vehicle (Co) starts to travel a downhill. When the projection beam (Fo) is projected backward, for example, as illustrated in FIGS. 3C and 3D, the projection beam (Fo) forming the light pattern projected on the road surface does not strike against the road surface at a place immediately after the own vehicle (Co) travels the top of the uphill or immediately after the own vehicle (Co) starts to travel the downhill. The projection beam (Fo) that has not struck against the road surface brushes against the road surface forward. The projection beam (Fo) may become relatively parallel to the road surface or travel upward in a region away from the own vehicle. The projection beam (Fo) may directly enter eyes of a driver of an oncoming vehicle (Cf) in the case of forward projection, or may directly enter eyes of a driver of a following vehicle (Cb) in the case of backward projection. If such a phenomenon actually occurs, the driver is strongly dazzled by the projection beam (Fo), which may cause a traffic accident.

It is desirable to provide a vehicle driving assistance apparatus that inhibits a projection beam that forms a light pattern projected on a road surface from dazzling drivers of other vehicles without striking against the road surface when the own vehicle travels a place where a downward gradient of the road surface increases as the distance from the own vehicle increases.

A vehicle driving assistance apparatus according to an embodiment of the disclosure is installed in a vehicle and displays a predetermined light pattern (Q) on a road surface around an own vehicle to enable a driver of the own vehicle, drivers of other vehicles, pedestrians, and an environmental condition detector to recognize the displayed light pattern. The vehicle driving assistance apparatus includes: a coherent light source (Ds); a road surface projection optical system (Up) configured to scan a light source beam (Fb) that is light emitted from the coherent light source (Ds), to output a projection beam (Fo), and project the light pattern (Q) on the road surface around the own vehicle; a road surface presence information retention section (Uw) configured to retain information, the information depending on a distance from the own vehicle and indicating whether the road surface is present in a region where the projection beam (Fo) is to be projected; and a control circuit (Ec) configured to control the coherent light source (Ds) and the road surface projection optical system (Up). The control circuit (Ec) stops the output of the projection beam toward a position at which absence of the road surface is indicated by information, in the region where the projection beam (Fo) is to be projected. The information is retained by the road surface presence information retention section (Uw).

It is possible to provide the vehicle driving assistance apparatus that inhibits the projection beam that forms the light pattern projected on the road surface from dazzling the drivers of the other vehicles without striking against the road surface when the own vehicle travels a place where the downward gradient of the road surface increases as the distance from the own vehicle increases.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a vehicle driving assistance apparatus according to an embodiment of the disclosure in a simplified manner.

FIG. 2 is a pattern diagram illustrating one mode of a part of the vehicle driving assistance apparatus according to the embodiment of the disclosure in a simplified manner.

FIGS. 3A to 3D are schematic diagrams each illustrating a concept relating to the technology of the vehicle driving assistance apparatus according to the embodiment of the disclosure.

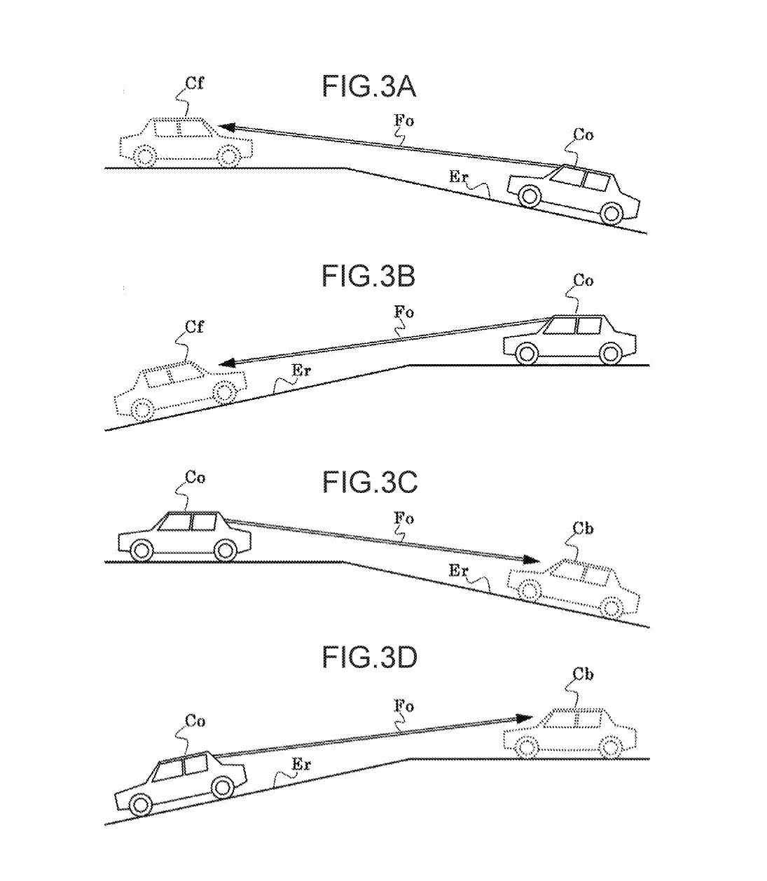

### DETAILED DESCRIPTION

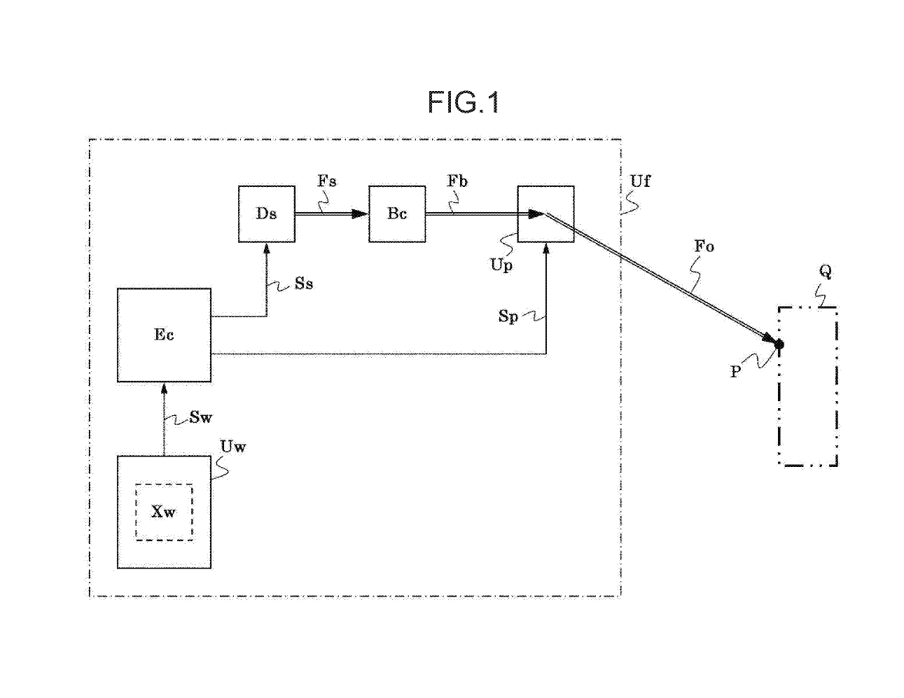

First, a configuration of a vehicle driving assistance apparatus according to an embodiment of the disclosure is described with reference to FIG. 1 that is a block diagram illustrating the vehicle driving assistance apparatus in a simplified manner. As illustrated in FIG. 1, the vehicle driving assistance apparatus (Uf) includes a road surface projection optical system (Up), a road surface presence information retention section (Uw), and a control circuit (Ec). The vehicle driving assistance apparatus (Uf) further includes a conversion optical system (Bc) and a coherent light source (Ds). The conversion optical system (Bc) provides a light source beam (Fb) to the road surface projection optical system (Up), and the coherent light source (Ds) provides emitted light (Fs) to the conversion optical system (Bc). The control circuit (Ec) performs control of the coherent light source (Ds) and the road surface projection optical system (Up). The emitted light (Fs) from the coherent light source (Ds) is converted into the light source beam (Fb) by the conversion optical system (Bc). The light source beam (Fb) is then provided to the road surface projection optical system (Up). The light source beam (Fb) may have a thickness suitable for being projected to a long distance. Note that the conversion optical system (Bc) may be provided as necessary. Examples of the conversion optical system (Bc) may include a collimator lens and a beam expander. Also, examples of the coherent light source (Ds) may include a semiconductor laser and a light source that converts a wavelength of light emitted from a semiconductor laser with use of a non-linear optical phenomenon such as high frequency generation and optical parametric effect.

The road surface projection optical system (Up) may include a two-dimensional deflector. The two-dimensional deflector may include two optical deflection devices such as an acousto-optical deflection device (AOD) and a galvanometer mirror that are so disposed as to be orthogonal in a deflection direction to each other. The two-dimensional deflector may independently drive the two optical deflection devices to emit the received beam toward an optional direction. In a case where the optical deflection device is the galvanometer mirror, a deflection angle of each of the two optical deflection devices may be defined based on a magnitude of a drive current flowing through a coil. In a case where the optical deflection device is the acousto-optical deflection device, the deflection angle of each of the two optical deflection devices may be defined based on a frequency of a high-frequency drive voltage applied to an ultrasonic wave transducer. The light source beam (Fb) that has entered the road surface projection optical system (Up) may be deflected in directions of azimuth angles θ and w into a projection beam (Fo) to be emitted to outside of the vehicle driving assistance apparatus (Uf). The emitted projection beam (Fo) may reach the road surface around the own vehicle to form a beam spot (P). Dynamically changing the azimuth angles θ and ω may continuously move the beam spot (P), which enables the road surface projection optical system (Up) to project an optional light pattern (Q) such as a straight line, a curved line, a circle, a polygon, and a character, on the road surface around the own vehicle.

For example, drawing a boundary of the traveling lane of the own vehicle as the light pattern (Q) may make it possible to cause drivers of other vehicles and pedestrians to give attention to the own vehicle and to allow a driver of the own vehicle to confirm adequacy of own steering. The traveling lane used herein refers to a region formed by moving the projection of the body of the own vehicle at a certain moment on the road surface along with the traveling of the vehicle and synthesizing the projected regions in a sum-set and cumulative manner. Alternatively, the traveling lane refers to a region formed by adding an allowance in a width direction necessary for safety to the region formed in the above-described manner. Further, the light pattern (Q) may be projected not only to attract human attention but also to allow an environmental condition detector to function. The environmental condition detector may include, for example, an image pickup device to acquire the reflected scattered light of the light pattern (Q) as an image, and identify whether a reflection scattering body is a road surface, a preceding vehicle, or an obstacle, thereby extracting information of safe state in front of the own vehicle.

The azimuth angles θ and ω used herein are defined below for convenience of the following description. When directing the traveling direction of the vehicle in straight traveling in a state where the vehicle driving assistance apparatus (Uf) is installed in the vehicle, a depression angle that is an angle of the deflected beam in a perpendicular plane, namely, an angle formed by the light beam with the road surface is denoted by θ, and an angle of the light beam in a horizontal plane is denoted by ψ, where an axis parallel to the flat road surface is referred to as a z-axis. Further, both of the angles θ and ω are referred to as the azimuth angles.

The control circuit (Ec) modulates electric power supplied to the coherent light source (Ds) with use of a light source modulation signal (Ss), controls the coherent light source (Ds) to be turned on or off, and controls intensity of light in lighting. Further, the control circuit (Ec) may transmit target values θp and ψp of the azimuth angles θ and ω to the road surface projection optical system (Up) with use of a target azimuth angle signal (Sp). A drive circuit included in the road surface projection optical system (Up) may control the drive current and the drive voltage of the optical deflection devices to achieve the target azimuth angles θp and ψp.

The road surface presence information retention section (Uw) retains road absence data (Sw) that is information depending on the distance from the own vehicle and indicating whether a road surface is present in a region where the projection beam (Fo) is to be projected. The control circuit (Ec) may receive the road surface absence data (Sw) to determine whether the road surface is present or absent in the region where the projection beam (Fo) is to be projected. Note that a method enabling the road surface presence information retention section (Uw) to acquire the road surface absence data (Sw) is described later. The control circuit (Ec) stops the output of the projection beam (Fo) toward the position at which absence of the road surface is indicated by the information in the region where the projection beam (Fo) is to be projected. At this time, the control circuit (Ec) controls one or both of the coherent light source (Ds) and the road surface projection optical system (Up).

Here, the road surface absence data (Sw) is information that depends on the distance from the own vehicle and indicates whether the road surface is present in the region where the projection beam (Fo) is to be projected. Thus, the road surface absence data (Sw) may be of any type as long as the road surface absence data (Sw) allows determination of a situation in which the projection beam (Fo) strikes against the road surface in a region within Z meters (where Z is a specific value such as 30) from the own vehicle but the downward gradient of the road surface increases and the road surface where the projection beam (Fo) is to be projected is absent in a region more than Z meters away from the own vehicle, which causes the projection beam (Fo) to be emitted to a far region. In other words, it is sufficient to determine the above-described situation with use of the road surface absence data (Sw). Thus, most simply, it is sufficient for the road surface absence data (Sw) to include, as numerical information, the distance Z from the own vehicle that is the limit value satisfying the condition that the road surface is present in a region where the projection beam (Fo) is to be projected.

Incidentally, in a situation where the road surface is flat over a long distance and the road surface is present up to the farthermost position where the projection beam (Fo) may possibly project the light pattern (Q) (in other words, the distance Z is substantially infinite), a specific value in a system (hardware and software) of the vehicle driving assistance apparatus (Uf), for example, a maximum value in the above-described numerical information or an improbable negative value is assigned to the value Zi in order to retain information of the situation as a value Zi of the distance Z. As a result, the value Zi may be handled as a predetermined factor.

When a height of the road surface projection optical system (Up) from the road surface is denoted by h, the azimuth angle θ is related with the distance Z by the following expression (Expression 1).

Z=h/tan θ

Therefore, when the azimuth angle θ corresponding to the distance Z is denoted by θz, it is sufficient for the road surface absence data (Sw) to include one of the distance Z or the angle θz. One of the values may be derived from the value of the other side with use of the expression 1 as necessary. At that time, a specific value such as zero and an improbable negative value may be assigned to the angle θz corresponding to the above-described value Zi. Note that, as is clear from the above description, the value Z is an upper limit of the distance and the value Oz is a lower limit of the azimuth angle to satisfy the condition that the road surface is present in the region where the projection beam (Fo) is to be projected.

To stop the output of the projection beam (Fo) projecting the light pattern (Q), for example, as the simplest way, the control circuit (Ec) may control the road surface projection optical system (Up) and the coherent light source (Ds) with indifference whether the road surface is present in the region where the projection beam (Fo) is to be projected. Then, the control circuit (Ec) may additionally perform control to turn off the coherent light source (Ds) when the azimuth angle θ or the target azimuth angle θp is equal to or lower than the lower limit θz that is obtained from the road surface absence data (Sw). Incidentally, in the case of such simple control, the road surface projection optical system (Up) may uselessly operate even during a period in which the coherent light source (Ds) is off by the additional control. Thus, the control circuit (Ec) may so perform control as to omit a part, of the control sequence, after the azimuth angle θ or the target azimuth angle θp becomes equal to or lower than the lower limit until the azimuth angle θ or the target azimuth angle θp exceeds the lower limit again, which makes it possible to avoid the useless operation mentioned above.

Note that in comparison of the actual azimuth angle θ or the target azimuth angle θp with the lower limit θz, the lower limit θz may be desirably evaluated on a safe side, namely, evaluated slightly larger in order to avoid occurrence of a phenomenon in which the projection beam (Fo) is emitted to a far region without striking against the road surface. The phenomenon may be derived from fluctuation of a depression angle of the projection beam (Fo) with the road surface as a reference caused by pitching in which floating/sinking occurs at different timings between a front part and a rear part of the car body, and other factors. Alternatively, consideration for safety is reinforced, and the coherent light source (Ds) may be turned off irrespective of the actual azimuth angle θ or the target azimuth angle θp during a period in which the lower limit θz does not correspond to the value Zi.

As mentioned above, the vehicle driving assistance apparatus (Uf) according to the embodiment of the disclosure scans the emitted light (Fs) from the coherent light source (Ds) such as a semiconductor laser, draws the predetermined light pattern (Q) on the road surface around the own vehicle, and enables a driver of the own vehicle, drivers of other vehicles, pedestrians, and the environmental condition detector to recognize the drawn light pattern (Q). This contributes to road safety and inhibits the projection beam that forms the light pattern projected on the road surface from dazzling the drivers of the other vehicles without striking against the road surface when the own vehicle travels a place where the downward gradient of the road surface increases as the distance from the own vehicle increases. This makes it possible to prevent occurrence of a traffic accident caused by dazzlement.

Various methods are available to realize the road surface presence information retention section (Uw). For example, GPS technology may be used to track the ever-changing position of the own vehicle, and information relating variation of the gradient of a front road surface or a rear road surface may be acquired from installed map information or map information downloaded through a radio wave, thereby generating the lower limit θz of the azimuth angle on the ever-changing front side or the ever-changing rear side of the own vehicle to satisfy the above-described condition that the road surface is present. At this time, mounting a gravity sensor and an acceleration sensor on the vehicle may make it possible to actually measure the ever-changing gradient of the road surface where the own vehicle is traveling. It is possible to enhance generation accuracy of the lower limit θz by employing the actual measured value. In particular, regarding the rear side of the own vehicle, it is possible to generate a substantially accurate lower limit θz from history data of the actual measured gradients of the road surface where the own vehicle has traveled.

Alternatively, the road surface presence information retention section (Uw) may be realized by a road surface absence detector (Xw) that detects absence of the road surface in the region away from the own vehicle by a certain distance. Some specific but non-limiting examples of the configuration thereof are described below. For example, when an image pickup device is provided to acquire a road condition (i.e., scenery) in front of or behind the own vehicle as an image and, for example, an image analysis apparatus determines whether a road surface is viewed on a horizontal line at a certain height in the image, this configuration functions as the road surface absence detector (Xw). Thus, it is possible to determine a limit depression angle at which the road surface is present, namely, to measure the lower limit θz of the azimuth angle satisfying the condition that the road surface is present, by examining an upper limit of the height at which the road surface is viewable on the image, based on the image analysis. As illumination for picking up an image of the road condition, outside light originally existing therearound, namely, sunlight and light from a street lamp may be used; however, invisible illumination light such as infrared light may be preferably applied only to a necessary solid angle region from the own vehicle. At this time, an illumination light source having a spectrum width as narrow as possible (for example, an infrared semiconductor laser) may be used and an image is picked up through an interference filter matching with the spectrum range disposed in front of the illumination light source. This makes it possible to perform measurement less affected by outside light.

Further, when the illumination light source is modulated to repeat lighting and extinction and only information coincident with the modulated frequency component is acquired, the measurement may become further less affected by outside light. In particular, using a technology of frame synchronization illumination image processing may make it possible to generate the road surface absence data (Sw) based on the measurement extremely less affected by outside light, and realize the excellent road surface absence detector. In this technology, the illumination light source is modulated in synchronization with a frame generation period of the image pickup device to alternately generate a frame with lighted illumination light source and a frame without lighted illumination light source, and then image data of the frame without lighted illumination light source is subtracted from image data of the frame with lighted illumination light source.

Alternatively, instead of the dedicated illumination light source as just mentioned above, the road surface projection optical system (Up) of the vehicle driving assistance apparatus (Uf) may project a test light pattern on a specific region of the road surface around the own vehicle. The reflected scattered light of the test light pattern may be acquired as an image with use of, for example, an image pickup device provided in the road surface projection optical system (Up), and the road surface absence detector based on the image analysis may be accordingly configured in a manner similar to the above description. Also in this case, the projection beam (Fo) from the road surface projection optical system (Up) may have a narrow spectrum width and may be subjected to modulation. This makes it possible to achieve processing using the interference filter and the frame synchronization illumination image processing mentioned above. In the case of this technology, however, the projection beam (Fo) may be visible light. Thus, to prevent the component eventually lower than the lower limit θz out of the test light pattern from dazzling drivers of other vehicles, it is necessary to intermittently perform short-time projection of the test light pattern.

Alternatively, as described later, the road surface absence detector based on the image analysis with use of the image pickup device just mentioned above may be applied to the control method in which the light pattern (Q) is projected while the lower limit θz is updated.

Further, as described later, the road surface absence detection may be performed by, without using the image pickup device, detecting the component inversely returned to the road surface projection optical system (Up) out of the rear scattered light on the road surface of the projection beam (Fo).

There is a following simple method to achieve the road surface presence information retention section (Uw), alternative to the automatically-operating road surface presence information retention section (Uw) that is achieved by acquiring the road surface gradient information or including the dedicated road surface absence detector (Xw). As with manual switching over between a high beam and a low beam of a headlight based on the determination of the driver, for example, the driver himself may determine whether the condition that the road surface is present in the region where the projection beam (Fo) is to be projected is satisfied up to a long distance, up to an intermediate distance, or up to a close distance, and manually operate the switch to switch over the above-described lower limit Oz of the azimuth angle in a step-wise manner, thereby achieving the road surface absence information retention section (Uw).

One fundamental note is supplementarily given here. A question may arise that it would be better not to stop the output of the projection beam in order to secure safety even though the projection beam disadvantageously causes a side effect of dazzlement to a driver of an oncoming vehicle when the own vehicle travels a place where the downward gradient of the road surface increases as the distance from the own vehicle increases. The projection beam under the condition that the projection beam does not strike against the road surface, however, does not form, on the road surface, a light pattern effectively recognizable by a human and the environment condition detector. Therefore, if such a projection beam is outputted, no safety is provided to the own vehicle. Such a projection beam may escape upward simply, wastefully strike against the other vehicles, or dazzle the driver of the oncoming vehicle as a side effect to enhance accident risk of the oncoming vehicle. Accordingly, it is necessary to stop the output of the projection beam under the above-described condition as the best way. Safety to be given by the projection of the light pattern is not given under such a condition. Therefore, to compensate the lowered safety, it is necessary to take any other effective measures beside the measure described in the embodiment of the disclosure.

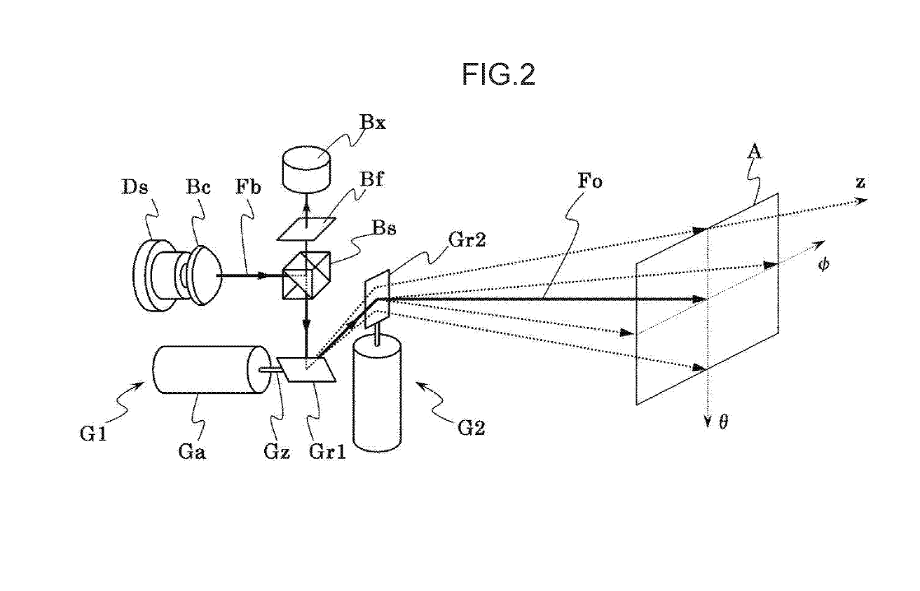

The embodiment of the disclosure is described below. First, an optical system including the coherent light source (Ds) and the road surface projection optical system (Up) that is configured using a galvanometer mirror is described with reference to FIG. 2. FIG. 2 is a pattern diagram illustrating one mode of a part of the vehicle driving assistance apparatus according to the embodiment of the disclosure. The emitted light from the coherent light source (Ds) that is configured of the semiconductor laser may be converted, through the conversion optical system (Bc), into the light source beam (Fb) including optical fluxes parallel to one another. The conversion optical system (Bc) may be a collimator using an aspherical lens. The light source beam (Fb) may enter a rotation mirror (Gr1) of a θ-deflection galvanometer mirror (G1) through a polarization beam splitter (Bs) that is described later. The rotation mirror (Gr1) may be fixed to an actuator shaft (Gz) that reciprocatively rotates in response to the drive of an actuator (Ga). The azimuth angle θ after deflection may be controlled by a drive current that is allowed to flow through the actuator (Ga) by the drive circuit (not illustrated) under the control of the control circuit (Ec).

The beam that has been reflected by the rotation mirror (Gr1) may enter a ψ-deflection galvanometer mirror (G2), and the azimuth angle ω after deflection may be controlled in a similar manner. The ψ-deflection galvanometer mirror (G2) has a configuration similar to that of the θ-deflection galvanometer mirror (G1) and has an actuator shaft orthogonal to the actuator shaft (Gz). The beam that has been reflected by a rotation mirror (Gr2) of the v-deflection galvanometer mirror (G2) may be outputted as the projection beam (Fo) from the road surface projection optical system (Up). The projection beam (Fo) may be two-dimensionally deflected in an optional direction in a solid angle region (A) and make it possible to project the light pattern (Q) on the road surface around the own vehicle. Note that as a position where the optical system in the drawing is to be disposed in a vehicle, two points, a right end and a left end of an upper side of a front windshield before a driver's seat from which the road surface in front of the vehicle can be seen are suitable. Alternatively, the optical system may be provided at only one position of a center of the upper side of the front windshield, namely, a gap between the front windshield and a room mirror.

In the case of the galvanometer mirror, a magnetic movable part including the mirror has moment of inertia to rotation. For example, when the drive current is varied in a stepwise manner in order to hop and move the azimuth angle coordinates θ and ψ, the current value does not correspond to the azimuth angles θ and ψ instantaneously because of the moment of inertia. The azimuth angles θ and ψ may rise at a finite speed and approximate to a steady-state value while performing ringing (attenuating oscillation). Accordingly, the azimuth angles θ and ψ may be detected and proportional-integral-derivative (PID) feedback control may be performed to improve a response speed, and the coherent light source (Ds) is turned off with use of the light source modulation signal (Ss) to allow unnecessary track of the beam spot (P) to be invisible during a period in which the ringing or overshooting occurs. As described above, when the driving is so performed as not to hop and move the azimuth angle coordinates θ and ψ, but to gradually vary the azimuth angles θ and ψ in order to project a straight line or a curved line, the ringing is difficult to occur. In such a case, however, error caused by operation delay may occur between the target azimuth angles θp and ψp and the azimuth angles θ and ω, and as a result, error of the position and the shape of the light pattern (Q) may occur. Therefore, correction is necessary.

Some examples to configure the road surface absence detector (Xw) generating information that depends on the distance from the own vehicle and indicates whether the road surface is present or absent in the region where the projection beam (Fo) is to be projected have been described above. In FIG. 2, illustration includes a configuration to achieve the road surface absence detector through detection of a component that is inversely returned to the road surface projection optical system (Up) out of the rear scattered light on the road surface of the projection beam (Fo). Assuming the case where the road surface is wet in the rainy weather, preferably, the vehicle driving assistance apparatus (Uf) may be so configured as to allow the projection beam (Fo) to become the P-polarized wave to the water surface in order to suppress regular reflection of light by the water on the road surface. Thus, in the drawing, when the coherent light source (Ds) is so disposed as to allow the polarized wave of the projection beam (Fo) to be parallel to the θ direction and the polarization beam splitter (Bs) is so disposed as to match thereto, about 100% of the light source beam (Fb) may be ideally reflected toward the rotation mirror (Gr1). When the projection beam (Fo) strikes against the road surface to cause the rear scattered light, the polarization plane may be typically rotated. Therefore, when the scattered light returns from the road surface through the rotation mirror (Gr2) and the rotation mirror (Gr1), the component that is S-polarized wave with respect to the road surface may pass through the polarization beam splitter (Bs), which may be detected by the light sensor (Bx).

For example, the light sensor (not illustrated) may detect the weak light of the light source beam (Fb) that has passed through the polarization beam splitter (Bs), which may makes it possible to constantly monitor the intensity of the light source beam. A threshold of the ratio of the amount detected by the light sensor (Bx) to the intensity of the light source beam is determined through, for example, an experiment in order to recognize whether the projection beam (Fo) strikes against the road surface. This makes it possible to allow the configuration to function as the road surface absence detector (Xw), and accordingly to achieve the road surface presence information retention section (Uw) that generates the road surface absence data (Sw). Note that the detection efficiency of the return light by the light sensor (Bx) depends on the distance Z that is a distance between the own vehicle and a position where the projection beam (Fo) strikes against the road surface. Therefore, the detection efficiency also depends on the azimuth angle θ joined with the distance Z by the above-described expression 1, and the above-described threshold may be desirably determined dependently on the azimuth angle θ.

Note that a narrow band filter (Bf) using, for example, an interference filter may be preferably disposed in front of the light sensor (Bx) in order to avoid influence of sunlight, road illumination light such as light from a street lamp, and disturbance light such as light emitted from other vehicles. Further, to enhance capability to avoid the influence of the disturbance light, amplitude modulation of an appropriate frequency may be performed on the drive current of the coherent light source (Ds), and the road surface absence data (Sw) may be generated based on a signal that has passed through an electric narrow band filter corresponding to the frequency subjected to the amplitude modulation, out of the signal detected by the light sensor (Bx). Alternatively, technologies of synchronous detection and a lock-in amplification circuit may be further used to generate the road surface absence data (Sw) with higher detection accuracy. Also, phase delay of the detection signal with respect to the modulation signal is measured when the detection signal is accurately acquired, which makes it possible to estimate the distance between the own vehicle and the position where the projection beam (Fo) strikes against the road surface.

As with the above description, the projection beam (Fo) may be visible light. Thus, to avoid dazzlement to the drivers of the other vehicles caused by the component eventually lower than the lower limit θz out of the light patterns (Q), a control system that projects the light pattern (Q) while updating the lower limit θz as described below may be preferable. Specifically, when the detection result of the road surface absence detector (Xw) is monitored while projecting the light pattern (Q) and it is determined that the projection beam (Fo) does not strike against the road surface, the value of the lower limit θz may be immediately updated, and the projection of the light pattern in a region in which the azimuth angle θ is lower than the lower limit θz is stopped. Then, to explore the possibilities that the lower limit θz is updated to a value lower than the current value, the short-time projection of the light pattern (Q) toward the region in which the azimuth angle θ is lower than the current lower limit θz may be intermittently performed to monitor the detection result of the road surface absence detector (Xw). When it is determined that the projection beam (Fo) strikes against the road surface, the lower limit θz may be updated, and this operation may be repeated toward the direction where the azimuth angle θ is gradually decreased.

Needless to say, the method using the road surface absence detector (Xw) based on the detection of the return light by the light sensor (Bx) just mentioned above may be applied to the method of projecting the test light pattern on the specific position on the road surface around the own vehicle by the road surface projection optical system (Up).

A vehicle driving assistance system installed in the vehicle may determine the shape of the traveling lane through simulation of the ever-changing position and the ever-changing direction of the own vehicle on the road surface until the near future. The vehicle driving assistance system may perform the simulation with use of a current steering angle by the driver, a change rate of the steering angle by steering, a current speed of the vehicle, an acceleration rate by operation of an accelerator, and an analysis of the road condition in front of the vehicle acquired with use of an image pickup device. The vehicle driving assistance system may determine the shape of the light pattern to be projected to enable the driver of the own vehicle, drivers of other vehicles, pedestrians, and the environmental condition detector to recognize the light pattern. Here, there may be a case where the light pattern to be projected is a boundary of the traveling lane itself. The length of the light pattern to be projected may depend on the speed of the own vehicle, and a priority area of the light pattern to be projected may become farther from the own vehicle as the speed of the own vehicle is high.

The vehicle driving assistance system may convert information indicating the shape of the light pattern to be projected, from the plane coordinates on the road surface into the azimuth angle coordinates θ and ω. The vehicle driving assistance system may transmit, to the control circuit (Ec) of the vehicle driving assistance apparatus (Uf) according to the embodiment of the disclosure, data of the converted information, for example, as a sequence of the target azimuth angles θp and ψp. The control circuit (Ec) may repeatedly read out the received sequence of the target azimuth angles θp and ψp, and generate the light source modulation signal (Ss) and the target azimuth angle signal (Sp) to control the coherent light source (Ds) and the road surface projection optical system (Up).

Incidentally, the control circuit (Ec) stops the output of the projection beam (Fo) toward the position at which absence of the road surface is indicated by information that is retained by the road surface presence information retention section (Uw), in the region where the projection beam (Fo) is to be projected. In other words, during a period in which the road surface projection optical system (Up) indicates a part of the sequence of the angles θp and ψp having the target angle θp lower than the lower limit θz obtained from the road surface absence data (Sw), the control circuit (Ec) controls the light source modulation signal (Ss) to turn off the coherent light source (Ds), thereby stopping the output of the projection beam (Fo) projecting the light pattern (Q).

It should be understood by those skilled in the art that various modifications, combinations, sub-combinations, and alterations may occur depending on design requirements and other factors insofar as they are within the scope of the appended claims or the equivalents thereof.

What is claimed is:

1. A vehicle driving assistance apparatus installed in an own vehicle and configured to display a predetermined light pattern on a road surface around the own vehicle to enable a driver of the vehicle, a driver of another vehicle, a pedestrian, and an environmental condition detector to recognize the displayed light pattern, the vehicle driving assistance apparatus comprising:
a coherent light source that emits a light source beam;
a road surface projection optical system configured to scan the light source beam and output a projection beam, the projection beam being the scanned light source beam having the predetermined light pattern;
a road surface presence information retention section configured to retain an information, the information depending on a distance from the own vehicle and indicating whether the road surface is present in a region where the projection beam is to be projected; and
a control circuit configured to control the coherent light source and the road surface projection optical system, the control circuit being configured to stop the output of the projection beam toward a position at which absence of the road surface is indicated by information, in the region where the projection beam is to be projected, the information being retained by the road surface presence information retention section.

2. The vehicle driving assistance apparatus according to claim 1, wherein the road surface presence information retention section includes a road surface absence detector that is configured to detect whether the road surface is present in the region where the projection beam is to be projected, the road surface absence detector is configured to generate a road surface absence data, the road surface absence data being information that depends on the distance from the own vehicle and indicates whether the road surface is present in the region where the projection beam is to be projected.

3. A vehicle driving assistance apparatus comprising:
a road surface projection optical system configured to output a projection beam;
a road surface presence information retention section configured to retain an information that, depending on a distance from a vehicle, indicates whether a road surface is present or absent in a region where the projection beam is to be projected; and
a control circuit configured to control the road surface projection optical system, the control circuit being configured to stop the output of the projection beam where the information indicates that the road surface is absent.

4. The vehicle driving assistance apparatus according to claim 3, wherein the road surface presence information retention section includes a road surface absence detector that is configured to detect whether the road surface is present or absent and to generate the information.
